(19) United States
(12) Patent Application Publication
(10) Pub. No.: US 2006/0007000 A1
(43) Pub. Date: Jan. 12, 2006

(54) File indexing and retrieval system employing RFID visual indicators

(76) Inventor: Rosita Yap, Pasadena, CA (US)

Correspondence Address: CHRISTIE, PARKER & HALE, LLP, PO BOX 7068, PASADENA, CA, 91109-7068, US

(21) Appl. No.: 11/177,914

(22) Filed: Jul. 7, 2005

Related U.S. Application Data
(60) Provisional application No. 60/586,338, filed on Jul. 7, 2004.

(51) Int. Cl. G08B 1/08; G08B 13/14

(52) U.S. Cl. 340/539.32; 340/572.1; 340/825.49

(57) ABSTRACT

A system for locating a stored item comprises a transmitter, a radio frequency identification tag attached to a stored item, and a search bar. The search bar in turn comprises an antenna for receiving a signal from at least one of the transmitter and the radio frequency identification tag, a wiring harness connected to the antenna, and a plurality of visual indicators connected to the wiring harness. A unique pattern is stored on the radio frequency identification tag. During the transmission of a signal by the transmitter containing a pattern matching the unique pattern stored on the radio frequency identification tag, the wiring harness of the search bar illuminates one or more visual indicators in the proximity of the radio frequency identification tag.

### CROSS REFERENCE TO RELATED APPLICATION

This application claims priority to and the benefit of Provisional Patent Application No. 60/586,338 filed on Jul. 7, 2004, the entire content of which is incorporated herein by reference.

### FIELD OF THE INVENTION

The present invention relates to radio frequency identification device (“RFID”) tags for use with file archiving systems. More particularly, a system is provided for locating an archived file or other item comprising a transmitter, a radio frequency identification tag attached to the archived file, and a search bar.

### BACKGROUND OF THE INVENTION

Known filing systems for storing large numbers of items exist which conform to prearranged physical filing schemes to aid in the search and retrieval of a particular one of the archived items. In order to preserve the order of the filing system, an item removed and returned to a shelf must be put back in a designated location to enable a later user to be able to find it in a predictable place. This system necessitates a great deal of time be spent maintaining the order of the archived items, and risks an item being mislaid in the event it is not re-shelved properly.

Furthermore, known RFID systems exist which are commonly used in retail operations and which employ RFID tags applied to merchandise along with a loop antenna coupled to a detector. The RFID “tags” may simply be a small sheet of a metal foil or a simple non-linear electronic device such as a diode. The presence of such a tag in the proximity of the loop antenna results in a distortion of the radio frequency signal transmitted by the antenna and discerned by the detector. Thus, the system functions simply as a proximity detector for such a tag.

More sophisticated RFID tags are known which employ an electronic device allowing the tag to respond upon receipt of radio frequency signals transmitted by the antenna by transmitting an identifying number or code stored on the tag itself. These so called “smart” tags are generally small label-like devices having a microchip and a miniature embedded antenna as well as an encapsulating material. These tags may be of the passive or active variety, wherein the active tags require an internal power supply. While the active tags can store a larger amount of information and return a signal over a longer range, they are much more expensive than passive tags, with the difference in some cases approaching the order of two hundred to one.

Additionally, RFID tags may be either inductively coupled or capacitively coupled. While inductively coiled RFID tags use a metal coil antenna responsive to a magnetic field rather than the conductive carbon ink antenna responsive to an electric field of the capacitively coupled RFID tags, both types of tags can employ a microprocessor capable of storing upwards of 96 bits of information.

An antenna produces an electronic “trigger” signal in the form of a radio frequency magnetic field which activates the RFID tag. The magnetic field serves as a carrier of power from the antenna to the RFID tag. The tag uses this trigger to generates a response in turn which is readable by the antenna. This response contains the information stored on the microprocessor of the RFID tag.

### SUMMARY OF THE INVENTION

In an exemplary embodiment, a system is provided for locating a stored item. The system comprises a transmitter, a radio frequency identification tag attached to a stored item, and a search bar. The search bar in turn comprises an antenna for receiving a signal from at least one of the transmitter and the radio frequency identification tag, a wiring harness connected to the antenna, and a plurality of visual indicators connected to the wiring harness. A unique pattern is stored on the radio frequency identification tag. During the transmission of a signal by the transmitter containing a pattern matching the unique pattern stored on the radio frequency identification tag, the wiring harness of the search bar illuminates one or more visual indicators in the proximity of the radio frequency identification tag.

In another embodiment, a distributed filing system comprises one or more individual communication cells having both a transceiver assembly and at least one search bar connected to the transceiver assembly, wherein the at least one search bar comprises an antenna for receiving a signal from at least one of the transceiver assembly and the radio frequency identification tag, a wiring harness connected to the antenna and in communication with the transceiver assembly, and a plurality of visual indicators connected to the wiring harness, a plurality of radio frequency identification tags storing unique patterns, wherein each of the plurality of radio frequency identification tags is associated with the transceiver assembly of a particular communication cell, and a central transmitter in communication with the transceiver assemblies of the communication cells. When a signal is transmitted by the transmitter to the transceiver assembly of an individual communication cell, a processor of the transceiver assembly attempts to match unique identification information of the signal with a unique pattern stored on a radio frequency identification tag associated with the transceiver assembly. When a match is made, the wiring harness of the search bar illuminates one or more visual indicators in the proximity of the radio frequency identification tag having a unique pattern matching the unique identification information of the signal.

In yet another embodiment, a method for managing a database system comprises periodically and automatically polling a plurality of radio frequency identification tags to induce transmission from the radio frequency identification tags of unique patterns stored thereon, and receiving the unique patterns transmitted by the radio frequency identification tags at a search bar having an antenna and a wiring harness connected thereto, searching a database of a transceiver connected to the wiring harness to locate files having unique patterns matching those received at the search bar, and updating presence and location of files stored in the database to reflect the unique patterns most recently received from the radio frequency identification tags. When the database is accessed by a user to locate a particular file associated with one of the plurality of radio frequency identification tags, the transceiver causes one or more of a plurality of visual indicators connected to the wiring harness of the search bar to illuminate to reflect the last known position of the file.

### BRIEF DESCRIPTION OF THE DRAWINGS

FIG. 1 shows a perspective view of a control unit according to one embodiment of the present invention;

FIG. 2 shows an alternative embodiment to FIG. 1 having a transmitter and a separate programming unit;

FIG. 3 is a perspective view showing yet another embodiment wherein a programming unit is attached as a peripheral device of a personal computer system;

FIG. 4 shows a perspective view of a search bar according to one embodiment of the present invention;

FIG. 5 shows an arrangement having multiple search bars installed on a shelf for use in retrieving one of a plurality of archived items;

FIG. 6 shows a side view of the embodiment of FIG. 5.

Before any embodiment of the invention is explained in detail it is to be understood that the invention is not limited in its application to the exemplary details of construction and arrangements set forth in the following description or illustrated in the drawings. The invention is capable of alternative embodiments and of being practiced or being carried out in various ways. Also, it is to be understood that the terminology used herein is for the purpose of illustrative description and should not be regarded as limiting.

### DETAILED DESCRIPTION OF THE INVENTION

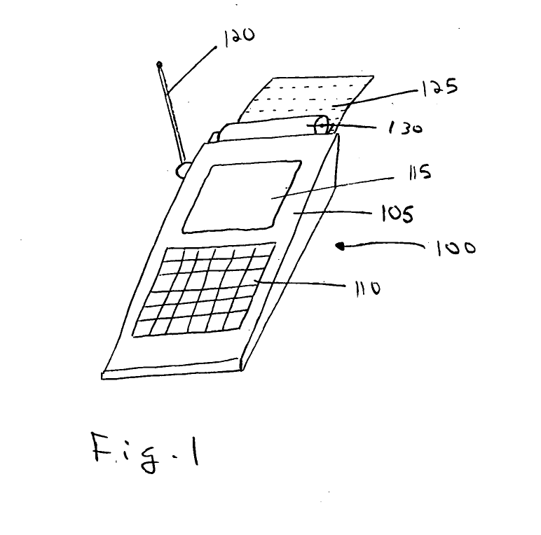

FIG. 1 shows a perspective view of a control unit 100 according to one embodiment of the present invention. The control unit 100 includes a case 105 housing electronic, radio and printing components for programming RFID tags, transmitting signals to programmed RFID tags applied to archived materials to aid in the retrieval of said materials, and maintaining a database of archived materials and previous transmissions sent to the RFID tags applied to archived materials. The control unit 100 is designed to be relatively small and portable. In one exemplary embodiment, the control unit 100 is approximately the size of a laptop computer. In another embodiment, the control unit 100 is approximately the size of a moderately sized calculator.

The control unit 100 also includes a data input 110 and a data display 115. A user wishing to archive a new item to be retrieved at a later date according to an embodiment of the present invention first inputs the name, title, or other identification corresponding to the item via the data input 110. The data display 115 provides visual feedback to the user during the inputting process.

Once the data corresponding to a new item to be archived is entered into the data input 110 and the proper command is given, the control unit 100 proceeds to use the data given to program an RFID tag with a unique pattern. By providing a user interface together with RFID programming capabilities in the control unit 100, the need to enter data for an archived file twice is avoided. This eliminates the potential for mistakes caused by human error when repeatedly entering similar data.

The control unit 100 includes a tag supply 130. The tag supply 130 may be mounted externally or internally in the control unit 100, and may be provided as a roll or folded stack of individual RFID tags. In the embodiment shown in FIG. 1, the tag supply 130 is a roll of programmable RFID tags mounted externally on the case 105 of the control unit 100. RFID tags are drawn into the case 105 of the control unit 100 as needed and programmed with the information entered by a user pertaining to a particular item to be archived. Subsequently, the programmed tags 125 are ejected from the case 105 so that they may be applied by a user to an item to be archived.

The method of programming the programmed tags 125 will be known to one skilled in the art, as is the division of RFID tags into read-only, read-write, and write-once read many (“WORM”) tags. WORM tags should be sufficient for the present invention, although if the user desires to reuse programmed tags 125 prepared for materials which are later discarded, the increased cost and complexity of using read-write RFID tags will be necessary.

A user wishing to retrieve a previously archived item uses the data input 110 to input a name, title, or other identification corresponding to the item to be retrieved. The data display 115 provides visual feedback to the user during this process as well. In one embodiment of the present invention, in addition to maintaining a database of data corresponding to the programmed tags 125 and items archived using the present system, the control unit 100 also stores data indicative of the previous several searches input by a user. This data enables a user to more easily perform repeated searches for commonly sought items. Furthermore, this data enables the user to briskly identify an unresponsive search bar, which indicates that the most frequently searched files may be away from the shelves and still with a previous user.

Once the data corresponding to an archived item is input using the data input 110 and the proper command is given, the control unit 100 sends a signal using an antenna 120 to an RFID tag, enabling a user to easily locate a desired item in the manner described hereinafter. In an exemplary embodiment, the control unit 100 transmits using an FM signal having a frequency of approximately 8 KHz. In another exemplary embodiment, the control unit 100 transmits using a signal having a frequency of approximately 13.5 MHz. In another exemplary embodiment, the control unit 100 transmits using a signal having a frequency of approximately 30 MHz. In yet another exemplary embodiment, the control unit 100 transmits a signal using the Post Office Code Standardization Advisory Group (“POCSAG”) protocol.

In a further embodiment, the control unit 100 continually searches its database as data is being entered by the user character by character at the data input 110. As soon as the control unit 100 has enough data from the user to narrow down the results of the search to a single record, a signal is sent to the antenna 120 to pinpoint the desired archived item without need of a separate command from the user to begin the search. In an exemplary embodiment, the control unit 100 includes a scanning protocol wherein the input of a sufficient minute pattern (e.g. a few letters, words of title or name) allows the protocol to search a database and automatically complete the title or name on the display 115. The user therefore need not type in complete data for multiple searches. After showing all the file search items on the display 115, the user may prompt a search command to begin multiple searches.

In an exemplary embodiment of the present invention, the programmed tags 125 are passive RFID tags powered by electromagnetic induction caused by receiving a signal sent from the antenna 120. In a further exemplary embodiment, the programmed tags 125 include microchips capable of storing between ten and thirty two bits of non-volatile data. In another embodiment, the programmed tags 125 include microchips capable of storing approximately sixty four bits of non-volatile data. In yet another embodiment, the programmed tags are joined to one another at perforated sections. When removed as individual tags, they measure in one embodiment between one half and 2 centimeters in width and between two and three centimeters in length. Finally, the programmed tags 125 may be provided with a self adhesive backing protected by a layer of backing paper. A user wishing to apply a programmed tag 125 to an item to be archived simply peels the backing off the tag and presses it to the item.

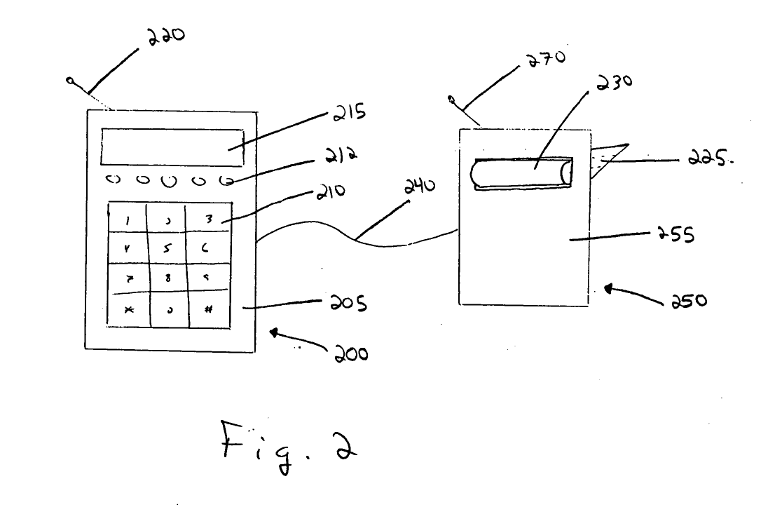

FIG. 2 shows an alternative embodiment of the present invention wherein the data storage, transmission and programming functions performed by the control unit 100 of FIG. 1 are divided between a transmitter 200 and a programming unit 250. As described above, the control unit 100 of FIG. 1 incorporates means for interacting with a user of the system, programming an RFID tag (and concurrently saving the information programmed on the tag to a database maintained on the control unit 100) and transmitting a signal to an RFID tag applied to an archived item. In contrast, the embodiment shown in FIG. 2 provides a transmitter 200 enclosed by a case 205 and having a data input 210 and a data display 215 for interacting with a user (i.e. receiving data from a user and providing feedback to a user). The embodiment shown in FIG. 2 also provides a separate programming unit 250 for programming RFID tags with a name, title, or other unique identification corresponding to an item to be archived. Because the programming functionality is provided in a separate unit to the transmitter 200, the transmitter 200 may comprise an exceedingly compact and easy to carry unit.

In the embodiment shown in FIG. 2, the transmitter 200 is provided with a data input 210 having an alphanumeric keypad. In alternative embodiments of the present invention, the data input 210 may comprise a full “qwerty” keyboard, a stylus, touchpad or other input means. An alphanumeric keypad is shown in FIG. 2 because it affords the data input 210 a satisfactory balance of functionality and compactness. If necessary, multi-function buttons 212 may be provided in a further alternative embodiment of the transmitter 200 to allow a greater range of possible input choices to the data input 210.

The data display 215 included in the transmitter 200 may in one embodiment be provided by an LCD display capable of displaying a single line of 8 characters, each having 8 bits of data, in the manner of a four function calculator. Depending on the complexity of the data to be displayed on the data display 215, a greater resolution may be needed. In another embodiment, the data display 215 comprises an LCD display capable of displaying eight lines of 21 characters each, wherein each character contains up to 64 bits of data, similar to many common graphing calculators currently in use. It will be understood to one skilled in the art that various embodiments are possible for the data display 215. As with the data input 210, a trade-off is presented in design of the data display 215 between the functionality and compactness of the display.

Regarding the programmer 250, a device is provided allowing the user of the present system to program RFID tags in a manner similar to that provided by the control unit 100 of FIG. 1. The programmer 250 has a case 255 and a tag supply 230. As with the tag supply 130 of the control unit 100 of FIG. 1, the individual RFID tags comprising the tag supply 230 may be mounted externally or internally in the programming unit 250, and may be provided as a roll or folded stack of tags. In the embodiment shown in FIG. 2, the tag supply 230 is a roll of programmable RFID tags mounted externally on the case 255 of the programming unit 250. The programming unit 250 uses the tag supply 230 to produce programmed tags 225 according to data received from the transmitter 200.

In an exemplary embodiment, the transmitter 200 and the programming unit 250 are provided with antennas 220 and 270, respectively. At least one of the transmitter 200 and the programming unit 250 has the capability to broadcast a signal through its antenna which is receivable by RFID tags programmed according to the present invention and applied to archived materials. In an exemplary embodiment of the present invention, the antennas 220 and 270 are also used to transmit data back and forth between the transmitter 200 and the programming unit 250. As such, the programming unit 250 is able to receive data entered by the user into the transmitter 200 to program an RFID tag with said data. In a further alternative embodiment, the transmitter 200 and the programming unit 250 are provided with a cable 240 to allow the transmission of data between the transmitter 200 and the programming unit 250.

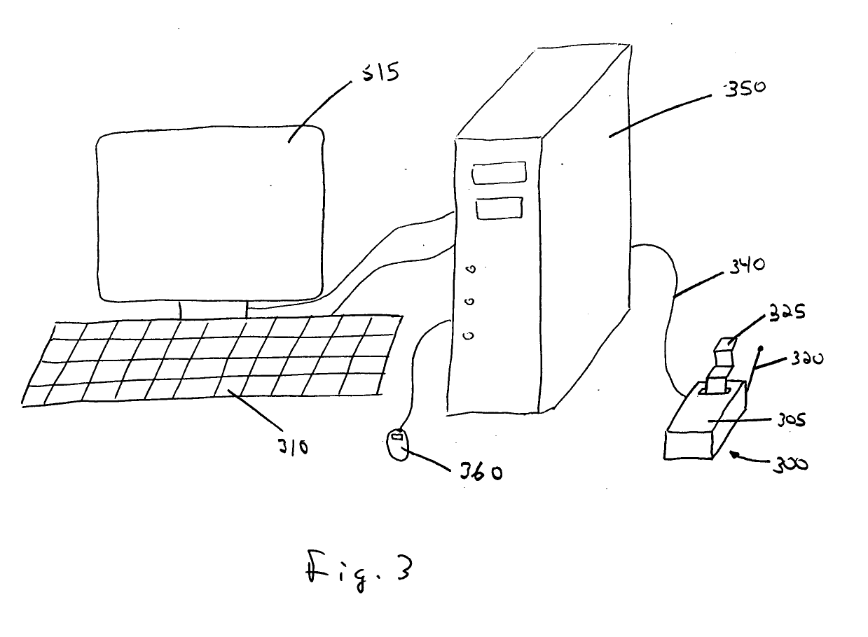

FIG. 3 shows a perspective view of yet another embodiment of the present invention. Here, a programming unit 300 is provided as a peripheral device for a personal computer system having a central processing unit (“CPU”) 350, a keyboard 310 and a monitor 315. This personal computer system allows a user to enter data and maintain a database of archived records as with the transmitter 200 shown in FIG. 2. A programming unit 300 is provided to produce programmed tags 325 having identification data corresponding to archived records. The programming unit 300 is also provided with an antenna 320 to allow a user of the system to transmit a signal to RFID tags of archived items slated for retrieval by the user. The programming unit 300 may be connected to the CPU with a cable 340 in a manner similar to other peripheral devices used with the personal computer system such as a mouse 360. Known protocols such as universal serial bus, firewire or the like may be used to transfer data between the CPU and the programming unit 300 along the cable 340.

In the embodiment shown in FIG. 3, the programming unit 300 is provided with an internal tag supply of a folded stack of RFID tags. After the programming unit 300 stores the name, title, or other identification to be stored on an RFID tag, the programmed tag 325 is passed out of the case 305. The embodiment shown in FIG. 3 lacks the portability of the embodiments shown in FIGS. 1 and 2. However, the provision of the personal computer system allows software which controls the programming unit 300 and stores data relating to archived items to be easily updated. Furthermore, the personal computer system shown in FIG. 3 may be incorporated easily into a network using known methods allowing data relating to items archived by the present system to be made available to multiple users.

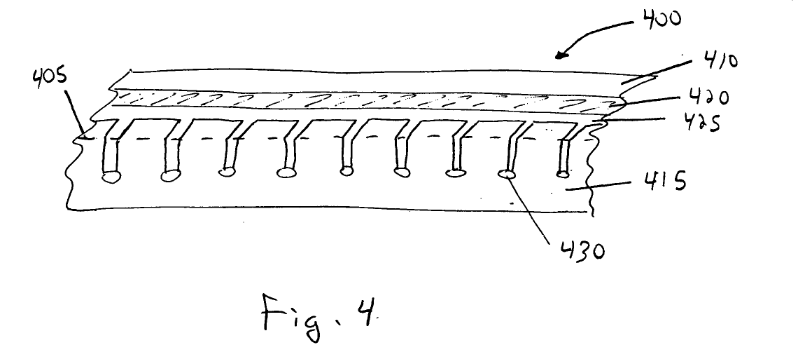

FIG. 4 shows a perspective view of a search bar 400 for use with an embodiment of the present invention. This search bar 400 serves as a signal receptor in the embodiment shown, and may be provided with a 110 volt power supply (not shown). In an alternate embodiment this power supply incorporates a power saving feature which switches off the current to the search bar 400 when the present system is not in use.

The search bar 400 may be comprised of a flexible tape or a stiffer bar incorporating materials such as plastic, glass, synthetics or the like. The search bar 400 has an antenna 420 provided along its length. In an alternative embodiment, the antenna 420 may be coiled, or copper tipped at intervals. The antenna may comprise a copper or aluminum element, optic fiber or an etched conductive ink.

The search bar 400 includes a horizontal portion 410 incorporating the antenna 420 described above. Said horizontal portion 410 is separated from a vertical portion 415 by a fold 405. In one exemplary embodiment, the horizontal portion 410 has a width of between two and three centimeters. In another exemplary embodiment, the vertical portion 415 has a width of between one and two centimeters, and forms approximately a perpendicular angle with the horizontal portion 410.

The vertical portion 415 of the search bar 400 is provided with a series of light emitting diodes (“LEDs”) 430. In an exemplary embodiment, these LEDs 430 are between three tenths and one centimeter wide. When the horizontal portion 410 of the search bar 400 is applied to the underside of a shelf or other supporting surface, the vertical portion 415 faces outwards so that the LEDs 430 are visible to a user of the system. These LEDs 430 are connected to a wiring harness 425 which runs from the vertical portion 415 to the horizontal portion 410 to interface with the antenna 420.

A user wishing to retrieve an archived item having an RFID tag attached thereto first operates the transmitter to send out a unique signal pattern in the manner discussed in the context of FIGS. 1-3 above. The transmitter may save a log of past searches which may be used to speed the execution of subsequent searches. The E/M field of the signal pattern, when applied to an RFID tag, acts as a carrier of power from the antenna to the RFID tag. In one exemplary embodiment of the present system, the signal pattern from the transmitter acts as a trigger to power and thus induce a response signal from each and every RFID tag within range of the transmitter. This response contains a unique pattern previously stored on the microprocessor of the RFID tag by the programming unit discussed in the context of FIGS. 1-3 above. In an alternative embodiment, the RFID tags may be fitted with modulation sensors which prevent them from transmitting or, alternately, receiving signals when a neighboring RFID tag is in use, i.e. modulating a signal of its own. These modulation sensors, which may also be placed along the search bar itself, help prevent interference between neighboring RFID tags.

Concurrently, the antenna 420 of the search bar 400 also receives the unique signal pattern from the transmitter. If an RFID tag is in the vicinity of the antenna 420, the wiring harness 425 which is electrically connected to the antenna 420 senses a match between the unique pattern from the transmitter and the unique pattern induced in the RFID tag. Because of the limited range of the signal induced at the RFID tag, this match is an inherently localized phenomenon. Thus, components of the wiring harness 425 are able to discern where along the length of the search bar 400 the archived item sought by the user is located.

In one embodiment small-scale printable sensors, chips or transistors may be provided as part of the wiring harness 425 etched alongside the antenna 420. These components illuminate the LEDs 430 when a match is found by the wiring harness 425 between received and induced signals in the vicinity of the origin of that signal. Thus, the ultimate effect is that when the search bar is secured below a shelf or other support for a plurality of archived items, a search performed according to the above embodiment will cause LEDs 430 to illuminate below an archived item having a matching RFID tag to the search performed. When the tag and/or archived item is removed from the shelf, the illumination of the LEDs 430 ceases.

In contrast to having a separate logic circuit in the wiring harness 425 for each LED 430 to sense a match between a signal received from the transmitter and a signal received from a proximate RFID tag, the wiring harness 425 may include in an alternative embodiment a single microcontroller or other processor, having multiplexed connections to each LED 430 and a sensor disposed above each LED 430. Alternatively, the wiring harness 425 may include a single microcontroller having only a single electrical connection to the antenna of the search bar. In this embodiment, the microcontroller uses the distance, timing and strength of signals received from RFID tags along the antenna to determine their approximate location.

In another embodiment, the wiring harness 425 may include analog to digital and digital to analog converters to aid in the processing of signals received from the transmitter and RFID tags. In an alternative embodiment, these devices may transmit digital signals, thus obviating the need for such converters.

In an alternative embodiment, a second set of LEDs (not shown) having a different color than the LEDs 430 may be provided. LEDS in this second set are designed to illuminate upon receiving any signal from a proximate RFID tag regardless of the matching discussed above. In this manner a user can easily diagnose whether a section of the search bar 400 is operating properly and verify that a file being sought is not in the system at all rather than simply not being read by the system. A pressure sensor may be provided on the search bar to provide further information as to the presence of a file in the system in the event that the search bar is unable to read that file's RFID tag.

In another potential embodiment, RFID tags are provided having an internal logic as well as a memory. This logic allows the tags themselves to determine whether a signal received from a transmitter contains an ID matching that which is stored in the memories of the tags. As such, while the E/M field created by the signal pattern from the transmitter powers each and every RFID tag within range of the transmitter, the tags can discriminate a signal that matches their own unique ID codes and thus a response signal will be induced from only one RFID tag.

Accordingly, the wiring harness 425 of the search bar 400 may be of a much simpler construction, given that it no longer need determine a match between two signals. If the search bar 400 senses a signal from any adjacent RFID tag, it will energize the LED light or lights 430 in that region. As is known in the art, the LEDs 430 may be inductively coupled to the RFID tags in this embodiment to achieve this effect. In this embodiment, the wiring harness 425 may comprise simply the electrical connection between the antenna 420 and the LEDs 430. Furthermore, in this embodiment the antenna 420 need not be a continuous structure, rather it may exist as a series of discontinuous antenna sections native to one or several LEDs 430. In another alternative embodiment, an LED may be provided directly on each RFID tag to indicate to a user of the system that the logic of that RFID tag has determined that the signal from the transmitter matches the unique ID stored on that RFID tag.

In an exemplary embodiment, the search bar may be provided with a repeater which receives a signal sent from the transmitter, amplifies it, and retransmits it to the RFID tags either directly or through the antenna 420.

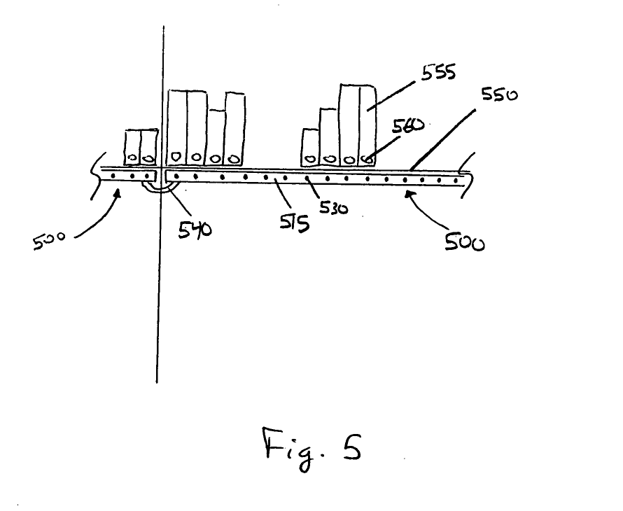

FIG. 5 shows an embodiment of the present invention having multiple search bars 500 installed along the underside of shelves 550. These search bars 500 are provided to aid in the retrieval of one of several archived items 555. The search bars 540 may be electrically connected to one another using a bar connector 540. In this manner, only the first search bar 500 installed in a system need be connected to an external power supply (not shown). The subsequent search bars 500 share the power supplied with the first search bar 500 and any intermediates via bar connectors 540. In one embodiment, the multiple search bars 500 may comprise together an individual cell in a distributed filing system. Files in each individual cell may be color coded for greater ease of searching. Furthermore, each individual cell may be provided with a transceiver assembly communicating with a central transmitter. In this embodiment, the transceiver assembly may act as a repeater to receive signals from the central transmitter and retransmit them to a plurality of radio frequency identification tags in the local cell, or it may be operated directly by a user, depending on convenience. Signals received from the central transmitter may contain a precoded sequences unique to one specific communication cell.

FIG. 5 shows the shelves 550 supporting a plurality of archived items 555. These items may comprise in various embodiments file folders, VHS cassettes, compact disk cases, books, or the like. Ordinarily, the physical arrangement of these archived items 555 must conform to a prearranged filing scheme to aid in the search and retrieval of a particular one of the archived items 555. An item removed and returned to the shelf 550 must be put back in a specific location to preserve to this filing scheme. Items stored in, say, alphabetical order must be put back in their alphabetical order; a misfiled item risks being lost in the shuffle, necessitating time consuming manual search for the desired item.

The search bars 540 are shown in FIG. 5 having their vertical portions 515 facing outwards. The LEDs 530 provided on the vertical portions 515 can thus indicate which archived item 555 features an RFID tag 560 corresponding to a signal sent out by the control unit 100 of FIG. 1, the transmitter 200 of FIG. 2, the programming unit 250 of FIG. 2, the programming unit 300 of FIG. 3, or other alternative embodiment. In an exemplary embodiment of the present invention, the RFID tag 560 is a passive, inductively coupled tag. In a further exemplary embodiment, the RFID tag 560 is a passive, capacitively coupled tag.

Thus, in the current system, a user of the system need only look for a flashing LED 530 to find a desired archived item 555, rather than having to search through a physical filing arrangement. In an alternative embodiment, where a very large number of archived items 555 are present, the RFID tags 560 may be color coded, and archived items 555 with like colored RFID tags 560 may be stored together. The color coding scheme in one embodiment relates to the first letter in the name of the archived item 555. Thus, while the archived items 555 are still being provided according to a set physical arrangement, it remains a relatively simple arrangement and a user of the system is able to find individual archived items 555 easily within color coding groups using the LEDs 530 without having to organized the archived items 555 within their color coding groups.

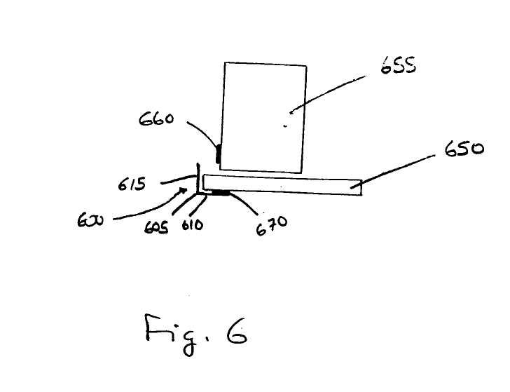

FIG. 6 shows a side view of an exemplary embodiment of the present invention wherein a search bar 600 is depicted having a horizontal portion 610 attached to the underside of a shelf 650 using an adhesive 670. In one embodiment, the adhesive 670 is a pressure sensitive self adhesive layer provided along the length of the search bar 600. The adhesive 670 may be covered with a backing tape (not shown) to be removed by the user at the time of installation of the search bar 600. In alternative embodiments, the horizontal portion 610 of the search bar 600 may be affixed to a shelf 650 using clips, tucks, a loop and pile fastener system or other means known to one skilled in the art.

The horizontal portion 610 of the search bar 600 is attached to a vertical portion 615 at a fold 605. In the embodiment shown, the vertical portion 615 extends upwards from the horizontal portion 610 and is oriented at an approximately ninety degree angle with the horizontal portion 610. In an alternative embodiment, the horizontal portion 610 rests on the main plane of the shelf 650, and the vertical portion 615 extends downward from the horizontal portion 610.

In a further alternative embodiment, the vertical portion may be oriented at an acute or obtuse angle with the horizontal portion 610. The angle must not be so obtuse that it prevents a user from observing the LEDs 430 provided on the vertical portion 615, nor should it be so acute that it prevents an overlap between the horizontal portion 610 and the shelf 650 sufficient to allow the adhesive 670 or other attachment means provided to secure the search bar 600 to the shelf 650. In yet another alternative embodiment, the two portions 610 and 615 of the search bar 600 may be provided in the same vertical plane, and the search bar 600 having this orientation may be affixed to a shelf 650 using clips, tucks, a loop and pile fastener system or other means known to one skilled in the art.

In an exemplary embodiment, the shelf 650 is a nonmetal shelf less than five centimeters in thickness. This ensures a strong wireless signal will be able to travel between the antenna in the horizontal portion 610 of the search bar 600 and the RFID tag 660 provided on the archived item 655. In a further exemplary embodiment, the RFID tag 660 is applied nearest the bottom of the archived item 655. This provides a short distance between the antenna and the RFID tag 660, further ensuring a strong wireless signal.

In an alternative embodiment, the shelf 650 may be provided with a mechanized device (not shown), enabling an archived item 655 to be partially ejected from the shelf 650 for easy visibility upon being the subject of a successful search.

In another alternative embodiment, the search bars 400, 500 or 600 may be provided with a buzzer or other device which gives the user an audio indication of each successful search processed by the system. This affords the user yet another way to quickly locate an archived item, as well as a quick way to judge the volume of results his search has returned.

What is claimed is:

1. A system for locating a stored item comprising:
a transmitter;
a radio frequency identification tag attached to a stored item; and
a search bar comprising:
an antenna for receiving a signal from at least one of the transmitter and the radio frequency identification tag;
a wiring harness connected to the antenna; and
a plurality of visual indicators connected to the wiring harness,
wherein a unique pattern is stored on the radio frequency identification tag, and
wherein during the transmission of a signal by the transmitter containing a pattern matching the unique pattern stored on the radio frequency identification tag, the wiring harness of the search bar illuminates one or more visual indicators in the proximity of the radio frequency identification tag.

2. The system of claim 1, wherein the transmitter comprises a data input accessible by a user,
wherein the user inputs one of a number or title corresponding to a file, and
wherein the transmitter uses a database to convert the one of a number or title to a unique pattern to be transmitted to the radio frequency identification tags.

3. The system of claim 1, further comprising a radio frequency identification tag programming device coupled to the transmitter.

4. The system of claim 3, wherein the radio frequency identification tag programming device and the transmitter are provided together as a single peripheral device which may be connected to a personal computer.

5. The system of claim 4, wherein a user makes a single input of an identification criteria to the data input of the transmitter, which identification criteria is both converted by the transmitter to a unique pattern and stored in the database, while also being used to program the unique pattern into a radio frequency identification tag.

6. The system of claim 1, wherein radio frequency identification tags include a discriminating circuit such that only a tag having the unique pattern matching the pattern in the signal sent by the transmitter emits a signal in response.

7. The system of claim 6, wherein radio frequency identification tags include modulation sensors which prevent the transmission from a first radio frequency identification tags in the event that a neighboring second radio frequency identification tag is determined by the modulation sensor to be transmitting a signal.

8. The system of claim 6, wherein visual indicators in the search bar may be one of inductively or capacitively coupled to a radio frequency identification tag so as to illuminate in response to a signal emitted by the radio frequency identification tag.

9. The system of claim 8, wherein the wiring harness consists of a series of electrical pathways between each visual indicator and the antenna.

10. The system of claim 4, wherein the radio frequency identification tag receives a first signal having a first frequency from the transmitter, and wherein the antenna receives in response a second signal having a second frequency different from the first frequency from the radio frequency identification tag.

11. The system of claim 10, wherein the first signal sent to the radio frequency identification tag from the transmitter is sent along the antenna of the search bar.

12. The system of claim 1, wherein the search bar further includes an audio indicator which emits a tone when one or more visual indicators in the proximity of the radio frequency identification tag are illuminated.

13. The system of claim 1, wherein the search bar further includes an AC power supply.

14. The system of claim 1, wherein the search bar further includes a repeater for receiving and retransmitting a signal from the transmitter.

15. The system of claim 1, further comprising a length of shelving, to an underside of which the search bar is attached with an adhesive.

16. The system of claim 15, wherein the length of shelving is nonmetal and less than 5 cm thick.

17. The system of claim 15, further comprising a mechanized device which partially ejects the stored item from the length of shelving when one or more visual indicators in the proximity of the radio frequency identification tag are illuminated.

18. A distributed filing system comprising:
one or more individual communication cells having both a transceiver assembly and at least one search bar connected to the transceiver assembly, wherein the at least one search bar comprises an antenna for receiving a signal from at least one of the transceiver assembly and the radio frequency identification tag, a wiring harness connected to the antenna and in communication with the transceiver assembly, and a plurality of visual indicators connected to the wiring harness;
a plurality of radio frequency identification tags storing unique patterns, wherein each of the plurality of radio frequency identification tags is associated with the transceiver assembly of a particular communication cell; and
a central transmitter in communication with the transceiver assemblies of the communication cells;
wherein when a signal is transmitted by the transmitter to the transceiver assembly of an individual communication cell, a processor of the transceiver assembly attempts to match unique identification information of the signal with a unique pattern stored on a radio frequency identification tag associated with the transceiver assembly, and
wherein when a match is made, the wiring harness of the search bar illuminates one or more visual indicators in the proximity of the radio frequency identification tag having a unique pattern matching the unique identification information of the signal.

19. The distributed filing system of claim 18, wherein the plurality of radio frequency identification tags are provided in separate color coded groups associated with specific individual communication cells.

20. The distributed filing system of claim 18, wherein the unique identification information of the signal contains a precoded sequence unique to one specific communication cell.

21. The distributed filing system of claim 18, wherein the transceiver of the search bar acts as a repeater to receive signals from the central transmitter and retransmit them to the plurality of radio frequency identification tags.

22. The distributed filing system of claim 18, wherein the search bar further includes a pressure sensor,
wherein the plurality of visual indicators includes indicators having both a first color and a second color,
wherein when a match is made, the wiring harness of the search bar illuminates one or more visual indicators of the first color in the proximity of the radio frequency identification tag having a unique pattern matching the unique identification information of the signal, and
wherein when the search bar receives a signal from a pressure sensor and does not receives a signal a radio frequency identification tag in the proximity of the pressure sensor, the wiring harness of the search bar illuminates one or more visual indicators of the second color in the proximity of the pressure sensor.

23. A method for managing a database system, comprising:
periodically and automatically polling a plurality of radio frequency identification tags to induce transmission from the radio frequency identification tags of unique patterns stored thereon;
receiving the unique patterns transmitted by the radio frequency identification tags at a search bar having an antenna and a wiring harness connected thereto;
searching a database of a transceiver connected to the wiring harness to locate files having unique patterns matching those received at the search bar; and
updating presence and location of files stored in the database to reflect the unique patterns most recently received from the radio frequency identification tags,
wherein when the database is accessed by a user to locate a particular file associated with one of the plurality of radio frequency identification tags, the transceiver causes one or more of a plurality of visual indicators connected to the wiring harness of the search bar to illuminate to reflect the last known position of the file.
